(19) United States
(12) Patent Application Publication
(10) Pub. No.: US 2007/0143446 A1
(43) Pub. Date: Jun. 21, 2007

(54) Methods, systems, and computer program products for installing an application from one peer to another including application configuration settings and data

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/313,573

(22) Filed: Dec. 21, 2005

(51) Int. Cl. G06F 15/16

(52) U.S. Cl. 709/219

(57) ABSTRACT

Methods, systems, and computer program products for installing an application are disclosed. According to one method, an installation of an application on a source device is detected. Responsive to detecting the application installation, a descriptor is produced including source-device-specific installation information. The descriptor is published to a descriptor data store accessible by a peer destination device. The descriptor is configured for use by the peer destination device for installing at least a portion of the application on the peer destination device.

### TECHNICAL FIELD

The subject matter described herein relates to installing applications on computers. More particularly, the subject matter described herein relates to methods, systems, and computer program products for installing an application from one peer to another including application configuration settings and data.

### BACKGROUND

Software applications have traditionally been distributed at sales points, such as a retail store or an Internet website. When purchased, a purchaser traditionally receives a physical installation medium, such as compact disk, diskette, or digital versatile disk (DVD).

When a user sees an application on a friend's machine that the user likes, the user must search for a place to purchase the application. This search may require the user to call local retail stores or travel to them, to perform web-based searches to find an Internet retailer, or mail order the software application which often takes several days to be fulfilled.

For a CD or DVD purchase, the user must find a retail store at which to purchase the software application or must wait for delivery. With any physical medium-based installation, the physical installation medium must be physically exchanged. Configuration settings and data associated with the purchaser's friend's machine will typically not be available at the moment of installation. A purchaser is often required to spend several hours configuring a new software application in order to have it operate like the friend's application that initially attracted the purchaser to buy the software application. As the complexity of software applications increases, the task of configuring them also increases.

Web installation is tedious. A user must find a uniform resource locator (URL) and deal with security and access controls in order to install an application on his or her computer. As with physical media, it is not possible to install an application using a friend's configuration settings and data via the web. The purchaser must still spend a large amount of time configuring the software application to achieve a configuration similar to the configuration on his or her friend's machine.

A server installation may be used to “push” an application onto a destination machine. This push installation has traditionally been managed by a system administrator and does not allow the ultimate user to choose any application configuration settings or data. Only those configuration settings and data chosen by the administrator are made available to the user. For server-based installation, the user typically is not able to adjust the configuration of the application installed and may thereby be unable to enhance the application environment.

Peer-to-peer (P2P) file sharing has been used for copying files between computers, but sharing applications and using existing P2P methods still lack the ability to install configuration settings and data. Further, P2P file sharing does not acquire a license for any application that may be copied, thereby resulting in an application that may either not run or that may run without being properly licensed.

Installation files are typically not left on a computer after the installation has completed. Accordingly, applications that may physically be copied may not properly install into the operating system environment when copied. Further, identification of installation images is often a complex task due to classification of installation images as executable files and storage of these installation images along with all of the other executable files associated with the application.

Licensing is another issue that has traditionally been managed at the point of sale with a seal on the installation medium that must be broken by the purchaser in order to access the installation medium and whereby breaking the seal acknowledges acceptance of the terms and conditions of the license agreement. For web-based purchases and during installation of many software applications, a licensing dialogue box with a radio button traditionally prompts a user to accept the licensing agreement prior to installation of the software application on the purchaser's personal computer.

It has also traditionally been very difficult, if not impossible, to determine whether a person's system will support an application without going through a formal installation process from a source medium. File system attributes do not typically reveal system requirements and the complexity of systems often prevent an average user from determining how to install such an application.

Accordingly, in light of these difficulties associated with conventional application installation, there exists a need for improved methods, systems, and computer program products for installing an application from one peer to another including application configuration settings and data.

### SUMMARY

According to one aspect, the subject matter described herein comprises methods, systems, and computer program products for providing for the installation of an application. One method includes detecting an installation of an application on a source device, responsive to detecting the application installation, producing a descriptor including source-device-specific installation information, and publishing the descriptor to a descriptor data store accessible by a peer destination device, wherein the descriptor is configured for use by the peer destination device for installing at least a portion of the application on the peer destination device.

The subject matter described herein providing for the installation of an application may be implemented using a computer program product comprising computer executable instructions embodied in a computer-readable medium. Exemplary computer-readable media suitable for implementing the subject matter described herein include disk memory devices, programmable logic devices, application specific integrated circuits, and downloadable electrical signals. In addition, a computer-readable medium that implements the subject matter described herein may be distributed across multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary distributed peer-based application installation system for allowing a user to install an application optionally including configuration settings and data from a distributed installation platform according to an embodiment of the subject matter described herein;

FIG. 2 is a flow chart illustrating a distributed peer-based application installation process for installing an application on a peer destination device by producing a descriptor in response to detecting the installation of the application according to an embodiment of the subject matter described herein;

FIG. 3 is a flow chart illustrating a distributed peer-based application installation process for installing an application on a peer destination device by use of a device remote to both the source peer and peer destination devices according to an embodiment of the subject matter described herein; and

FIG. 4 is a flow chart illustrating a distributed peer-based application installation process for installing an application at a peer destination device using a variety of descriptor types according to an embodiment of the subject matter described herein.

### DETAILED DESCRIPTION

In view of the problems described above with respect to traditional approaches to application installation, the subject matter described herein provides for installation of an application from one peer to another including application configuration settings and data. Where previously a user was required to manage the installation process and configure the application after installation, the methods, systems, and computer program products described herein manage the installation and configuration process for the user and allow data files to be initialized and associated with the application. By adapting the initial installation process on the source computer to describe the installation options and to publish applications that are available for installation, peer computers may locate applications for installation and initiate the installation process without the complications discussed above in relation to traditional installation and configuration processes. By adapting the applications installed to update configuration options as users modify application configurations, peer computers may be able to install applications with configuration settings and data similar to those of the source computer.

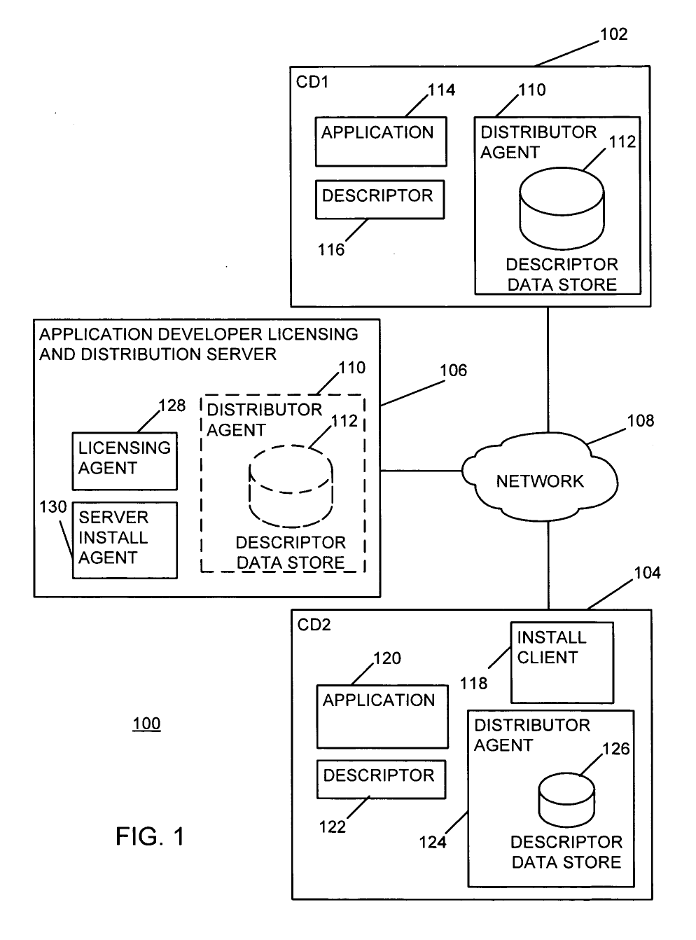

FIG. 1 illustrates an exemplary distributed peer-based application installation system 100 for allowing a user to install an application optionally including configuration settings and data from a distributed installation platform. Distributed peer-based application installation system 100 may be used to virally distribute applications including configuration settings and data for each installation performed. Software application developers may design software applications to use distributed peer-based application installation system 100 and thereby may reduce installation media costs and installation server bandwidth requirements, as will be discussed in more detail below.

In FIG. 1, system 100 includes computing device 1 (CD1) 102, CD2 104, and application developer licensing and distribution server 106 interconnected through network 108. CD1 and CD2 may include any computing device. For example, CD1 and CD2 may be a personal computer, a PDA, a cell phone or any other computing device capable of running an application with a user interface. CD1 102 includes distributor agent 110 and descriptor data store 112. Distributor agent 110 is a peer-based application distribution interface used to coordinate the distribution of applications, configuration settings, and data from a source device to a peer destination device. Descriptor data store 112 may be accessed by peer destination devices. As illustrated by the dashed-line representations of these components in FIG. 1, distributor agent 110 and descriptor data store 112 may be located on application developer licensing and distribution server 106 without departing from the scope of the subject matter described herein.

Application 114 installed on CD1 102 may be installed with a descriptor 116 produced at the time of installation, or descriptor 116 may be produced at a later time in response to a request from a peer to install a copy of application 114. When produced at installation time, descriptor 116 may be referenced or stored in descriptor data store 112 and published for access by other computers, such as CD2 104, over network 108, or may be stored separately. When produced in response to a peer detecting an installation of application 114 and issuing an installation request, descriptor 116 may be created and used either with or without storage for future use. Descriptor 116 may include source-device-specific installation information including an identifier of the source device. Descriptor 116 may also include a URL pointing to a server where the application installation files may be located. Accordingly, installation files may be installed from a server, such as application developer licensing and distribution server 106, or from CD1 102, while configuration settings and data may be “optionally” installed from the source device, such as CD1 102. Configuration settings, such as which modules or portions of application 114 were installed on CD1 102, and data may be included within descriptor 116.

Distributor agent 110 may be used to distribute application 114 in response to an installation request identifying either application 114 or descriptor 116 within descriptor data store 112.

CD2 104 includes an install client 118 which may search descriptor data stores, such as descriptor data store 112, for applications that may be installed. Install client 118 may use a protocol designed for locating and distributing applications and data. When descriptor 116 for application 114 has been located by install client 118, application 114 may be installed on CD2 104 as application 120 including configuration settings and data. During the installation process, descriptor 122 may be created. A new distributor agent 124 and descriptor data store 126 may also be created on CD2 104, and descriptor 122 may be referenced or stored within descriptor data store 126 and published for access by other computer users.

During the process of installing application 114 of CD1 102 as application 120 of CD2 104, application developer licensing and distribution server 106 may be used to provide licensing and installation support. Licensing agent 128 may be accessed to obtain valid licensing for application 120. During the installation process, the user of CD2 104 may interface with licensing agent 128 through install client 118 to provide credit card or other billing information suitable for acquisition of a valid license in order to run application 120. Server install agent 130 may also be used to manage compatibility issues between CD1 102 and CD2 104. For example, in the event that CD1 102 and CD2 104 have different operating systems or different hardware platforms which may require a different set of drivers or other components of application 114 in order for it to be used on CD2 104, server install agent 130 may provide an appropriate set of drivers or components to be used on CD2 104 by application 120. Alternatively, server install agent 130 may be used to provide an entire application 120 to CD2 104 while configuration settings and data for application 114 may be installed from CD1 102.

Distributed peer-based application installation system 100 provides a flexible, viral, application installation environment whereby a user may install and license an application including configuration settings and data without the extensive configuration requirements of traditional systems. Additionally, in the event that application 120 already resides on CD2 104, version upgrades along with configuration settings and data copying may also be performed by distributed peer-based application installation system 100. In this way, applications, settings, and data may be migrated from one machine to another. As well, when a new computer is purchased, a user may migrate applications, configuration settings, and data from an old computer to a new computer without the burden of installing all software applications from scratch and reconfiguring each application for the user's preferred settings. Organizations may also utilize distributed peer-based application installation system 100 to replicate a particular installation with settings and data by performing an initial installation on one system and virally distributing it to other computers used by the organization. Developers may also use distributed peer-based application installation system 100 to distribute software applications and enlist application owners to register their software for subsequent distribution to new customers. In this way, developers may offload their servers. As an incentive for existing customers to do this, existing customers may be paid a fee for each application installation done from their machine. It should be noted that, if desired, a computer owner may limit access to configuration settings and data.

Exemplary uses of distributed peer-based application installation system 100 include installing a copy of a department calendar client on one computer and distributing the calendar client to other department members. The calendar client may be distributed after an initial installation and configuration by sending a link in an email message to all department members. The link may reference a descriptor, such as descriptor 116, within a descriptor data store, such as descriptor data store 112. By following the link, each department member may virally install the client calendar on their local computer. During the installation process, the execution of the installation image may check for dependencies and install any missing software it depends on by retrieving it from well-known locations, such as application developer licensing and distribution server 106, as discussed above. The execution of the installation image may also obtain a license from a license server, such as licensing agent 128, and during the installation period configuration settings and data may be copied from the initially installed application, such as application 114 on CD1 102, to the various department members' computers.

In another scenario, a new employee may be tasked with setting up a new computer to use printers, address lists, and settings for inter-departmental and client communications. The new employee may be directed to a website at which he or she may browse the network to find a machine of a coworker or a source machine designated for viral distribution of applications, and may initiate set up of the new computer by selecting descriptors, such as descriptor 116, for each application that he or she desires to install.

In an alternate embodiment, a computer user may actually buy an application from a friend's or colleague's machine. In the United States, it is easy to envision someone needing to complete their income taxes on April 14th. Supposing that the taxpayer lives a great distance from the nearest store at which he or she can purchase tax preparation software, he or she may find it very difficult to acquire an income tax software application, install it, configure it, and complete the necessary income tax forms by April 15th. However, if the taxpayer knows that a friend has used an application for tax preparation and that the user already has a configured copy of the application on his or her computer, the taxpayer may use distributed peer-based application installation system 100 to purchase the software pre-configured and ready to use.

The taxpayer's friend may provide a communication port, such as a home network or a network such as network 108, by which the taxpayer may connect to the friend's machine. The taxpayer may then search the descriptor data store on the friend's machine until the descriptor, such as descriptor 116, for the tax preparation software application is found. The taxpayer may then “pull” the application to his or her machine by initiating an installation of the application on his or her machine, including the connection to the vendor's website to enter credit card or other payment information for licensing purposes. A license key may be provided by the application developer and the taxpayer may quickly begin tax preparation. Alternatively, the taxpayer's friend may access the distributor agent, such as distributor agent 110, on his or her machine and perform a “push” operation to direct the distributor agent to install the application on the taxpayer's machine without departing from the scope of the subject matter described herein. Further, when a home network is used and current access to the web is not available, a user may download an application including configuration settings and data, and then access the web later for licensing without departing from the scope of the subject matter described herein.

A descriptor, such as descriptor 116, may include a profile for the application with which it is associated. This profile may be used for installing, upgrading, and configuring the application. Descriptor 116 may be created when application 114 is installed and may be modified each time a user of CD1 102 changes configuration settings for application 114. In this way, descriptor 116 may include all configuration information and settings selected by the user. As well, descriptor 116 may include information related to data and data files used by application 114. By including configuration settings and data resources within descriptor 116, distributed peer-based application installation system 100 may be used to virally install applications, including configuration settings and data, from one peer machine to another.

Descriptors may be typed and may be configured as tag-based descriptor files, using a format such as extensible markup language (XML), wherein each tag may be associated with either data or executable code. Each tag within an XML descriptor file may be associated with a handler which is capable of using the information in the descriptor to initiate the requested operation. A descriptor may be obtained from an application through a published application programming interface (API) or may reside as a separate file on a computer with a recognizable name or type or may be placed in a published location for access by other computer users.

Examples of descriptor data structures will now be presented and described. In the following descriptor examples, the descriptors are shown in an extensible markup language (XML) schema or grammar. Many other formats and representations of the descriptors are possible, including executable descriptors, and all are considered within the scope of the subject matter described herein.

A descriptor data structure may be associated with a source application at the time of installation. As discussed above, when the application is installed, a descriptor may be created and certain fields populated with content to identify information that may be of use during a future peer installation. The following represents an exemplary copy descriptor suitable for a push-type installation.

<descriptor>
<copy source=“C:\settings\appsettings” target=“%prompt%” >

<file name=“*”/file>

</copy>
</descriptor>

The descriptor tags (beginning and ending) define the boundaries of the descriptor. The copy tags include locations of information or executable code that may be used to carry out the installation process to a destination peer. As can be seen from the copy portion of the descriptor, tags for source, target, and file are present. The source tag identifies a directory, appsettings, for application settings. When the installation first occurs, the application settings may include default installation settings. When configuration changes are made to the installed application by a user, the contents of the application settings directory may be modified to reflect the changes.

The contents of the application settings directory may be tailored to each application by the application developer. The target tag may specify an action to take place on the destination (target) peer or code to run either on a server or on the destination peer. In this case, the descriptor indicates that a prompt should be placed upon the destination peer user interface to allow the peer user to enter a destination for the installation. The file tag includes a name tag, which in this embodiment includes an asterisk denoting that all files are to be copied during the install process. A source application user may specify that the version of an application that resides on his or her machine may be shared, that the setup for the application may be shared, and that the user's data may also be shared. Use of the name tag to identify limitations on files that may be copied may allow a user more flexibility in relation to application sharing.

The following represents an exemplary executable descriptor suitable for a push-type installation with the source machine acting in conjunction with a server which provides installation files for the destination peer machine.

<descriptor>

<exe source=“C:\settings\app\setupClient.exe %dest%” >

<param key=“settings”
value=“C:\settings\app\appSettings.xml” /param>

</exe>
<exe target=“http://myapp.com/targetInstaller %dest%” /exe>

</descriptor>

The first pair of exe tags include an executable file, setupClient.exe, located on the source machine. The source tag within an exe tag may have a different purpose from the source tag discussed above in relation to the basic copy descriptor. For the exe tag, the source tag may specify a file name to execute on the source peer machine. In this exemplary embodiment, the setupClient.exe file may be run on the source machine and may be passed a destination parameter, % dest %, indicating the destination peer machine. Any suitable format for the destination parameter may be used, including, for example, the internet protocol (IP) address of the destination peer machine. The param tag includes a key tag with an associated value tag to be used by the setupClient.exe file. In the present embodiment, the key tag indicates that the settings for the application may be found in the file appsettings.xml file located on the source peer machine. The appsettings.xml file is another schema understandable by setupClient.exe that may be used to archive specific information related to the application setup on the source machine.

The second pair of exe tags includes a target tag that may be used to identify the location of an installation program to be executed and that may coordinate with setupClient.exe during the installation process. As can be seen from the descriptor, the targetInstaller executable is located on a server device, and, as such, becomes a server install agent that may be used during the destination peer application installation process. When invoked, the targetInstaller executable may communicate with the setupClient.exe file to retrieve a version identifier for the source peer application, application settings, and any constraints placed upon application copying by the source peer user (e.g., limitations on setup information and user data copying).

The following represents an exemplary executable descriptor suitable for an installation including a uniform resource locator (URL) tag within the descriptor for identifying an installation executable located on a server for installing the application on the destination peer machine. This URL descriptor may be used for either a “push” installation where the source machine makes a hypertext transfer protocol (HTTP request) or a “pull” installation where the destination peer makes the HTTP request.

<descriptor>

<url target=“http://myapp.com/targetInstaller %dest%” >

<param key=“settings”
value=“C:\settings\app\appSettings.xml” /param >

</url>

</descriptor>

The URL tag includes a target tag and a param tag. The functionality of these two tags is similar to the functionality discussed above in relation to the executable descriptor. The URL tag may be used to specify that the installer program resides at a URL address. The param tag with the associated key and value tags may identify source peer information that may be used by the installer. As with the executable descriptor, a % dest % parameter may be passed to the web-based server to identify the installation destination, and the source peer settings information may be stored in appsettings.xml which may be another schema understandable by the targetInstaller application and that may be used to archive specific information related to the application setup on the source machine. The application settings available from the source peer may include, for example, a version identifier for the source peer application, application settings, and any constraints placed upon application copying by the source peer user (e.g., limitations on setup information and user data copying).

A proprietary descriptor may also be used to allow an executable object to be instantiated when the descriptor is used, thereby conserving memory related to the installation process and allocating memory when needed to execute and installation. The following represents an exemplary proprietary descriptor suitable for performing an application installation including a java class tag within the descriptor for use by a descriptor parser, such as distributor agent 110, to instantiate an installer object for installing the application on the destination peer machine. This proprietary descriptor may be used for either a “push” installation where the source machine instantiates the executable object or a “pull” installation where the destination peer instantiates the executable object.

<descriptor>

<com.ipac-co.targetAgent appID=“0xAB789FC3” %dest% >

<param key=“settings”
value=“C:\settings\app\appSettings.xml” /param>

</com.ipac-co.targetAgent>

</descriptor>

The java class tag, com.ipac-co.targetAgent, is a proprietary tag handler and includes an appID tag to identify the application that is to be copied to the destination peer machine when the targetAgent object is instantiated. As with other executable descriptors discussed above, a % dest % parameter may be passed to the installer instance to identify the installation destination and a param tag may include key and value tags identifying a schema by which the targetAgent object may understand which attributes of the source application are available for copying to the destination peer.

The descriptor types discussed above may be combined to create more versatile descriptors. The following combination descriptor includes both a copy descriptor and a proprietary descriptor.

<descriptor>

<copy source=“C:settings\app\appSettings.xml”

target=“temp” /copy>

<com.ipac-co.targetAgent appID=“0xAB789FC3” >

<exe target=“configureAgent” /exe>

</com.ipac-co.targetAgent>

</descriptor>

The combined descriptor represents aspects discussed above. Accordingly, reference to the discussion above should provide sufficient insight into the aspects of the combined descriptor.

A distributor agent, such as distributor agent 110, may publish descriptors and make them available to other computer users. Distributor agent 110 may be a web-based application or may be a simple mail transfer protocol (SMTP Internet email) or a file transfer protocol (FTP) service. Distributor agent 110 may use a proprietary protocol or an open source protocol.

A descriptor data store, such as descriptor data store 112, may include a source component that advertises the entities that may be distributed from a computer, such as CD1 102. Descriptor data store 112 may be open and accessible to all computers connected to CD1 102 or may require authentication and may support access control to restrict access to distributable entities. Descriptor data store 112 may, for example, be a web server using HTTP or FTP and may be accessible via a well-known port or path, for example, port 9090 and the http-based descriptor service. A user could direct his or her web browser to http://peerHostName:9090 and browse at that location for available descriptors in the form of text descriptions, icons, or any other suitable representation.

Descriptors may also be stored in a file share. For example, a shared directory may be created and published on a network, such //peerHostName/applicationDescriptors, which represents an SMB address. Distributor agent 110 may also provide an application programming interface (API) much like the browser embodiment discussed above, or may allow client-side applications to use descriptor information to perform a search.

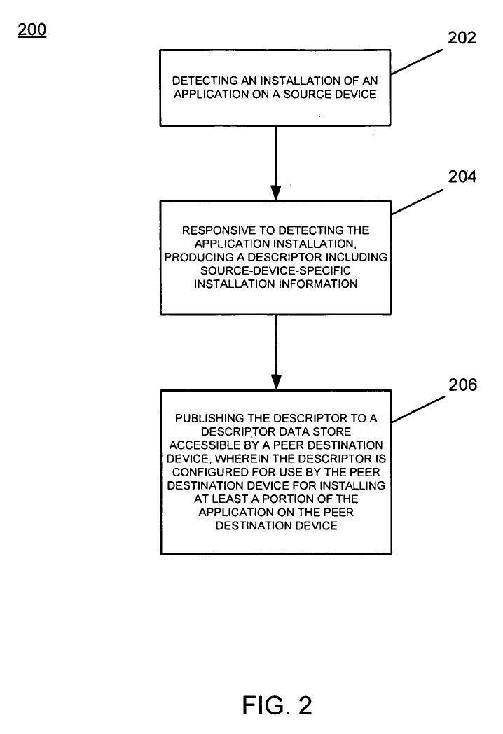

FIG. 2 illustrates an exemplary distributed peer-based application installation process 200 for installing an application on a peer destination device by producing a descriptor in response to detecting the installation of the application. At block 202, distributed peer-based application installation process 200 may detect an installation of an application on a source device. At block 204, responsive to detecting the application installation, distributed peer-based application installation process 200 may produce a descriptor including source-device-specific installation information. At block 206, distributed peer-based application installation process 200 may publish the descriptor to a descriptor data store accessible by a peer destination device. The descriptor is configured for use by the peer destination device for installing at least a portion of the application on the peer destination device.

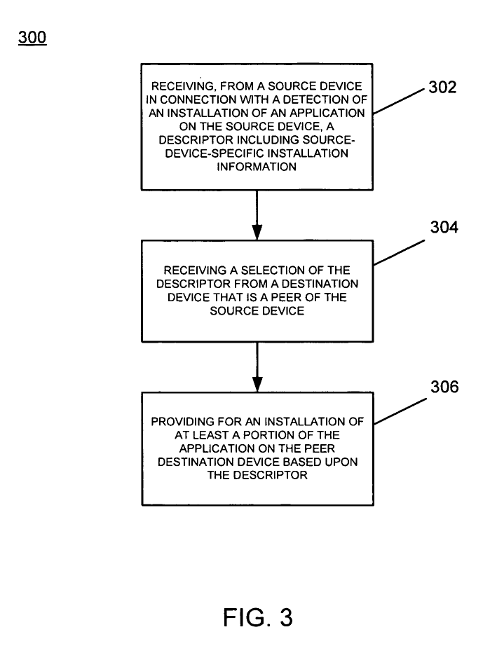

FIG. 3 illustrates an exemplary distributed peer-based application installation process 300 for installing an application on a peer destination device by use of a device remote to both the source peer and peer destination devices. At block 302, distributed peer-based application installation process 300 may receive, from a source device in connection with a detection of an installation of an application on the source device, a descriptor including source-device-specific installation information. At block 304, distributed peer-based application installation process 300 may receive a selection of the descriptor from a destination device that is a peer of the source device. At block 306, distributed peer-based application installation process 300 may provide for an installation of at least a portion of the application on the peer destination device based upon the descriptor.

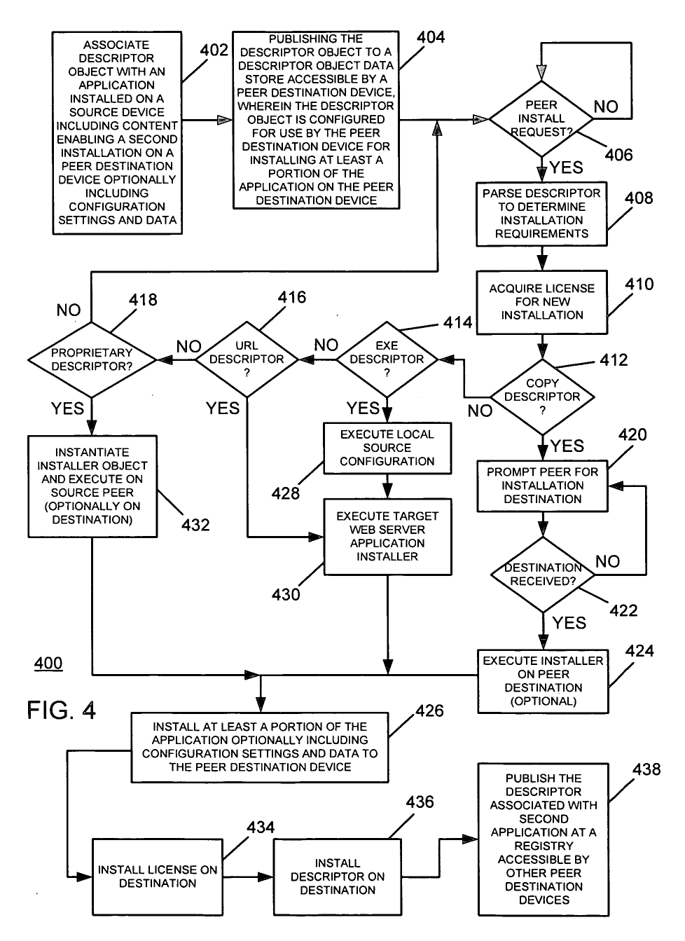

FIG. 4 illustrates an exemplary distributed peer-based application installation process 400 for installing an application at a peer destination device using a variety of descriptor types. At block 402, a descriptor may be associated with an application installed on a source device, including content enabling a second installation on a peer destination device optionally including configuration settings and data. At block 404, the descriptor associated with the application may be published to a descriptor data store accessible by a peer destination device, wherein the descriptor is configured for use by the peer destination device for installing at least a portion of the application on the peer destination device. At decision point 406, distributed peer-based application installation process 400 may wait for a peer installation request.

When a peer installation request has been received, the descriptor may be parsed to determine installation requirements for the new installation at block 408. A license for the new installation may be acquired at block 410. As discussed above, a licensing agent, such as licensing agent 128, may be used to obtain a license for the new installation.

At decision point 412, a determination may be made as to whether the descriptor is a copy descriptor. If not, decision point 414 may be used to determine whether the descriptor is an executable descriptor. If the descriptor is not an executable descriptor, decision point 416 may be used to determine whether the descriptor is a URL descriptor. If the descriptor is not a URL descriptor, decision point 418 may be used to determine if the descriptor is a proprietary descriptor. If the descriptor is not of a known type, distributed peer-based application installation process may return to decision point 406 to await a new peer installation request. For simplicity, error handling mechanisms will not be discussed herein. However, many error handling mechanisms are possible and all are considered within the scope of the subject matter discussed herein.

When the descriptor has been determined to be a copy descriptor at decision point 412, the peer destination device may be prompted for an installation location on the peer destination device at block 420. At decision point 422, distributed peer-based application installation process 400 may wait for a destination to be received from the peer and may iteratively re-prompt the peer until a destination has been received. Though not depicted in FIG. 4, a timeout mechanism may be utilized to prevent livelock. When a destination has been received, as determined at decision point 422, an installer may be optionally executed on the peer destination device at block 424 or installation execution may continue from the local computer. At block 426, at least a portion of the application optionally including configuration settings and data may be installed to the peer destination device.

When the descriptor has been determined to be an executable descriptor at decision point 414, a local source configuration may be executed at block 428. Operating in conjunction with the local source configuration execution, a target web server application installer may be executed at block 430. Alternatively, executable code on or copied to the destination peer device may be executed to install or assist in the installation of the application. The local source configuration executable and the target web server application installer executable may work in conjunction with one another to install a version of the application appropriate for the hardware and operating system of the peer destination. When the application version on the source device is appropriate for the peer destination device, the application, optionally including all configuration settings and data may be sourced from the source device. Alternatively, when a different version should be installed on the peer destination device, the target web server application installer may assemble all of the appropriate files for that version and the local source configuration executable may optionally provide the configuration settings and data for the application. In this event, the target web server application installer may modify or adapt the configuration settings to the new version and may convert any data to allow it to be usable by the new version of the application installed the peer destination device.

When the descriptor has been determined to be a URL descriptor at decision point 416, a target web server application installer may be executed at block 430. When the descriptor has been determined to be a proprietary descriptor at decision point 418, an installer object associated with the proprietary tag may be instantiated and executed on the source peer device at block 432.

As with decision point 412 which resulted in a transition to block 426, each of decision points 414, 416, and 418 likewise result in a transition to block 426. After installing at least portion of the application, optionally including configuration settings and data, to the peer destination device, the license acquired for the new installation at block 410 may be installed on the peer destination device at block 434. A new descriptor may be installed on the destination at block 436. This new descriptor may include information to allow other peer computers to install the application by publishing the descriptor associated with the application installed on the peer destination device at a registry accessible by other peer destination devices at block 438. The new descriptor may be created at a later point in time without departing from the scope of the subject matter described herein.

A system for distributed peer-based application installation may include means for detecting an installation of an application on a source device. For example, in FIG. 1, application developer licensing and distribution server 106 may detect the presence of an application, such as application 114, on a source device, such as CD1 102. CD1 102 may also detect the presence of application 114.

The system may also include means for, responsive to detecting the application installation, producing a descriptor including source-device-specific installation information. For example, in FIG. 1, distributor agent 110 on either of application developer licensing and distribution server 106 and CD1 102 may produce a descriptor, such as descriptor 116, including source-device-specific installation information.

The system may also include means for publishing the descriptor to a descriptor data store accessible by a peer destination device, wherein the descriptor is configured for use by the a peer destination device for installing at least a portion of the application on the peer destination device. For example, in FIG. 1, descriptor data store 112 may operate as a descriptor data store accessible by a peer destination device, such as CD2 104, and publish a descriptor, such as descriptor 116, configured for use by the peer destination device for installing at least a portion of an application, such as application 114, on the peer destination device. Descriptor data store 112 may reside on either application developer licensing and distribution server 106 or on CD1 102.

Another system for distributed peer-based application installation may include means for receiving, from a source device, a descriptor associated with an installation of an application at the source device and including source-device-specific installation information. For example, in FIG. 1, application developer licensing and distribution server 106 may receive, from a source device, such as CD1 102, a descriptor, such as descriptor 116, associated with an installation of an application, such as application 114, at the source device and including source-device-specific installation information.

The system may also include means for receiving a selection of the descriptor from a destination device that is a peer of the source device. Application developer licensing and distribution server 106 may receiving a selection of a descriptor, such as descriptor 116, from a destination device, such as CD2 104, that is a peer of a source device, such as CD1 102.

The system may also include means for providing for an installation of least a portion of the application on the peer destination device based on the descriptor. Application developer licensing and distribution server 106 may provide for an installation of at least a portion of an application, such as application 114, on a peer destination device, such as CD2 104, based on a descriptor, such as descriptor 116.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing for the installation of an application, the method comprising:
detecting an installation of an application on a source device;
responsive to detecting the application installation, producing a descriptor including source-device-specific installation information; and
publishing the descriptor to a descriptor data store accessible by a peer destination device, wherein the descriptor is configured for use by the peer destination device for installing at least a portion of the application on the peer destination device.

2. The method of claim 1 comprising installing the at least a portion of the application on the peer destination device by executing instructions on the source device.

3. The method of claim 1 comprising installing the at least a portion of the application on the peer destination device by executing instructions on a server device other than the source device and the peer destination device.

4. The method of claim 1 comprising installing the at least a portion of the application on the peer destination device by executing instructions on the peer destination device.

5. The method of claim 1 comprising installing source-device-specific installation information for the application on the peer destination device.

6. The method of claim 1 wherein the descriptor comprises a copy descriptor.

7. The method of claim 6 wherein the copy descriptor includes instructions for prompting the peer destination device for an installation destination.

8. The method of claim 6 wherein the copy descriptor includes instructions for providing the copy descriptor to the peer destination device and wherein installing the at least a portion of the application is performed by executing instructions on the peer destination device.

9. The method of claim 1 wherein the descriptor comprises an executable descriptor.

10. The method of claim 9 wherein the executable descriptor includes instructions for providing the executable descriptor to a server device other than the source device and the peer destination device and wherein installing the at least a portion of the application is performed by executing instructions on each of the source device, the server device.

11. The method of claim 1 wherein the descriptor comprises a uniform resource locator (URL) descriptor.

12. The method of claim 11 wherein the URL descriptor includes instructions for providing the URL descriptor to a server device other than the source device and the peer destination device and wherein installing the at least a portion of the application is performed by executing instructions on the server device.

13. The method of claim 1 wherein the descriptor comprises a proprietary descriptor for identifying a class type designed to execute instructions for installing the at least a portion of the application when instantiated.

14. The method of claim 13 comprising installing the at least a portion of the application by instantiating the class type identified within the proprietary descriptor on the source device and executing instructions on the source device.

15. The method of claim 13 comprising installing the at least a portion of the application by instantiating the class type identified within the proprietary descriptor on the peer destination device and executing instructions on the peer destination device.

16. The method of claim 1 comprising acquiring a license for installing the at least a portion of the application installed on the peer destination device.

17. The method of claim 16 comprising installing the license on the peer destination device.

18. The method of claim 1 further comprising producing another descriptor associated with an installation of the at least a portion of the application on the peer destination device, the other descriptor including content enabling a subsequent installation of the at least a portion of the application on another peer destination device.

19. The method of claim 18 comprising publishing the other descriptor to a descriptor data store accessible by the other peer destination device.

20. The method of claim 1 wherein publishing the descriptor includes publishing the descriptor via a web browser interface.

21. The method of claim 1 wherein publishing the descriptor includes publishing the descriptor via a simple mail transfer protocol (SMTP) file share.

22. The method of claim 1 wherein publishing the descriptor includes publishing the descriptor via an application programming interface (API).

23. The method of claim 1 comprising locating the descriptor data store on a server device other than the source device.

24. A method for providing for the installation of an application, the method comprising:
receiving, from a source device and in connection with detection of an installation of an application at the source device, a descriptor including source-device-specific installation information;
receiving a selection of the descriptor from a destination device that is a peer of the source device; and
providing for an installation of at least a portion of the application on the peer destination device based on the descriptor.

25. The method of claim 24 wherein providing for the installation of the at least a portion of the application on the peer destination device includes executing instructions on the source device.

26. The method of claim 24 wherein providing for the installation of the at least a portion of the application on the peer destination device includes executing instructions on a server device other than the source device and the peer destination device.

27. The method of claim 24 wherein providing for the installation of the at least a portion of the application on the peer destination device includes executing instructions on the peer destination device.

28. The method of claim 24 comprising installing source-device-specific installation information for the application on the peer destination device.

29. The method of claim 24 wherein the descriptor comprises a copy descriptor.

30. The method of claim 29 wherein the copy descriptor includes instructions for prompting the peer destination device for an installation destination.

31. The method of claim 29 wherein the copy descriptor includes instructions for providing the copy descriptor to the peer destination device and wherein installing the at least a portion of the application is performed by executing instructions on the peer destination device.

32. The method of claim 24 wherein the descriptor comprises an executable descriptor.

33. The method of claim 32 wherein the executable descriptor includes instructions for providing the executable descriptor to a server device other than the source device and the peer destination device and wherein installing the at least a portion of the application is performed by executing instructions on each of the source device and the server device.

34. The method of claim 24 wherein the descriptor comprises a uniform resource locator (URL) descriptor.

35. The method of claim 34 wherein the URL descriptor includes instructions for providing the URL descriptor to a server device other than the source device and the peer destination device and wherein installing the at least a portion of the application is performed by executing instructions on the server device.

36. The method of claim 24 wherein the descriptor comprises a proprietary descriptor for identifying a class type designed to execute instructions for installing the at least a portion of the application when instantiated.

37. The method of claim 36 comprising installing the at least a portion of the application by instantiating the class type identified within the proprietary descriptor on the source device and executing instructions on the source device.

38. The method of claim 36 comprising installing the at least a portion of the application by instantiating the class type identified within the proprietary descriptor on the peer destination device and executing instructions on the peer destination device.

39. A system for providing for the installation of an application, the system comprising:
a distributor agent adapted to detect an installation of a application on a source device and to produce a descriptor including source-device-specific installation information; and
a descriptor data store accessible by a peer destination device adapted to publish the descriptor, wherein the descriptor is configured for use by the peer destination device for installing at least a portion of the application on the peer destination device.

40. The system of claim 39 wherein the distributor agent is adapted to install the at least a portion of the application on the peer destination device by executing instructions on the source device.

41. The system of claim 39 comprising a server device, wherein the distributor agent is adapted to install the at least a portion of the application on the peer destination device by executing instructions on the server device.

42. The system of claim 39 wherein the distributor agent is adapted to install the at least a portion of the application on the peer destination device by executing instructions on the peer destination device.

43. The system of claim 39 wherein the distributor agent is adapted to install the source-device-specific installation information for the application on the peer destination device.

44. The system of claim 39 wherein the descriptor comprises a copy descriptor including instructions for prompting the peer destination device for an installation destination.

45. The system of claim 44 wherein the distributor agent is adapted to parse the copy descriptor and to prompt the peer destination device for an installation destination based upon the instructions for prompting the peer destination device for the installation destination.

46. The system of claim 44 wherein the distributor agent is adapted to provide the copy descriptor to the peer destination device and to install the at least a portion of the application by executing instructions on the peer destination device.

47. The system of claim 39 wherein the descriptor comprises an executable descriptor.

48. The system of claim 47 wherein the distributor agent is adapted to parse the executable descriptor and to a server device other than the source device and the peer destination device and to install the at least a portion of the application by executing instructions on each of the source device and the server device.

49. The system of claim 39 wherein the descriptor comprises a uniform resource locator (URL) descriptor.

50. The system of claim 49 wherein the distributor agent is adapted to parse the URL descriptor and to provide the URL descriptor descriptor to a server device other than the source device and the peer destination device and to install the at least a portion of the application by executing instructions on the server device.

51. The system of claim 39 wherein the descriptor comprises a proprietary descriptor for identifying a class type designed to execute instructions for installing the at least a portion of the application when instantiated.

52. The system of claim 51 wherein the distributor agent is adapted to install the at least a portion of the application by instantiating the class type identified within the proprietary descriptor on the source device and to execute instructions on the source device.

53. The system of claim 51 wherein the distributor agent is adapted to install the at least a portion of the application by instantiating the class type identified within the proprietary descriptor on the peer destination device and to execute instructions on the peer destination device.

54. The system of claim 39 wherein the distributor agent is adapted to acquire a license for installing the at least a portion of the application installed on the peer destination device.

55. The system of claim 54 wherein the distributor agent is adapted to install the license on the peer destination device.

56. The system of claim 39 wherein the peer destination device is adapted to install the at least a portion of the application on the peer destination device and to create another distributor agent adapted to detect the installation of the at least a portion of the application on the peer destination device and to produce another descriptor associated with the installation of the at least a portion of the application on the peer destination device including peer-destination-device-specific installation information, the other descriptor including content enabling a subsequent installation of the at least a portion of the application on another peer destination device.

57. The system of claim 56 comprising another descriptor data store adapted to publish the other descriptor, wherein the other descriptor is configured for use by the other peer destination device for installing the at least a portion of the application on the other peer destination device.

58. The system of claim 39 wherein the descriptor data store includes a web browser interface to allow a search of the descriptor data store on the source device to make the descriptor data store accessible by the peer destination device.

59. The system of claim 39 wherein the descriptor data store includes a simple mail transfer protocol (SMTP) file share to allow a search of the descriptor data store on the source device to make the descriptor data store accessible by the peer destination device.

60. The system of claim 39 wherein the descriptor data store includes an application programming interface (API) to allow a search of the descriptor data store on the source device to make the descriptor data store accessible by the peer destination device.

61. The system of claim 39 comprising a server device for locating and accessing the descriptor data store.

62. A system for providing for the installation of an application, the system comprising:
means for detecting an installation of an application on a source device;
means for, responsive to detecting the application installation, producing a descriptor including source-device-specific installation information; and
means for publishing the descriptor to a descriptor data store accessible by a peer destination device, wherein the descriptor is configured for use by the peer destination device for installing at least a portion of the application on the peer destination device.

63. A system for providing for the installation of an application, the system comprising:
means for receiving, from a source device, a descriptor associated with an installation of an application at the source device and including source-device-specific installation information;
means for receiving a selection of the descriptor from a destination device that is a peer of the source device; and
means for providing for an installation of at least a portion of the application on the peer destination device based on the descriptor.

64. A computer program product comprising computer-executable instructions embodied in a computer-readable medium for performing steps comprising:
detecting an installation of an application on a source device;
responsive to detecting the application installation, producing a descriptor including source-device-specific installation information; and
publishing the descriptor to a descriptor data store accessible by a peer destination device, wherein the descriptor is configured for use by the peer destination device for installing at least a portion of the application on the peer destination device.
